(19) United States
(12) Patent Application Publication
(10) Pub. No.: US 2013/0017526 A1
(43) Pub. Date: Jan. 17, 2013

(54) METHOD AND APPARATUS FOR SHARING A TABLET COMPUTER DURING A LEARNING SESSION

(71) Applicants: Chris Nguyen, Baltimore, MD (US); Chris Hoehn-Saric, Miami, FL (US); Lee Clinton, Baltimore, MD (US)

(72) Inventors: Chris Nguyen, Baltimore, MD (US); Chris Hoehn-Saric, Miami, FL (US); Lee Clinton, Baltimore, MD (US)

(73) Assignee: LEARNING CENTER OF THE FUTURE, INC., Baltimore, MD (US)

(21) Appl. No.: 13/180,049

(22) Filed: Jul. 11, 2011

(51) Int. Cl. G09B 7/00

(52) U.S. Cl. 434/362

(57) ABSTRACT

Methods and apparatus for displaying data on a multi-user display device are disclosed. A first subset of the data is displayed in a first orientation, such that the displayed data is in a proper orientation with respect to a first user located at a first side of the display device. Upon receiving a user input requesting to share the data, a second subset of the data is displayed in a second different orientation, such that the displayed data is in the proper orientation with respect to a second user located at a second different side of the display device. Which subset of the data is displayed to which user is based at least in part on identifying information associated with each user.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### TECHNICAL FIELD

The present application relates in general to data sharing and, in particular, to methods, systems and devices for displaying data during a collaborative session during which two or more users or operators share the same computer display or screen.

### BACKGROUND

Collaboration involves the active participation between two or more people to achieve a common goal. When two or more people engage in collaborative activities, they often require or desire the use of computers to facilitate the exchange of information back and forth among collaborators.

In certain known systems, multiple users work at side-by-side computers. In these systems, each individual works at his or her own personal computer, which typically includes a single mouse, a single keyboard, and a single visual display.

It is also known to have multiple users working together at the same computer. While it is possible for two or more users to work together using the standard setup of a personal computer (e.g., one display device or screen, one mouse, and one keyboard), attempting to collaborate under these conditions can be awkward and unnatural. Only a single user may be sitting in front of and interacting with the computer at any given time. This results in users having to switch or shift seats each time a new user wishes to sit in front of the computer.

In other known systems, multiple users work together at a distance through networked computers. Although networks have enabled people to collaborate at a distance, they do not require or take advantage of the benefits of multiple people working together in the same location.

Despite the proliferation and increasing functionality of electronic communication tools, face-to-face interactions among collaborators remain extremely important. Two or more people who are facing each other can see each other, influencing several aspects of collaboration such as monitoring and coordination of action.

When two or more people are collaborating in a face-to-face environment, this often involves sitting at or around a table. People working at a table can sit facing each other and share a workspace that allows them to cooperatively work on a task at the same time. For people who wish to work together in such face-to-face environments, the systems described above offer limited support.

It is known to use tablet or slate-type computers in collaborative environments. Tablet computers provide the functionality of personal computers and have added mobility. They are typically equipped with a touch screen and/or stylus, such that a user may input commands and move between applications by touching the stylus to various parts of the screen or to virtual buttons on the screen. Use of such tablet computers encourages collaboration because multiple users can gather (such as around a table) and work together on a single tablet.

Although the tablet computer offers increased flexibility and mobility over notebook, non-portable, portable and lap-top computers, there are some drawbacks to the use of tablet computers by more than one person, particularly in face-to-face environments. For example, the visual information displayed by the tablet computer is typically oriented such that only one user can see the data in a correct or proper orientation. That is, only a first user can view the data as it was intended to be viewed by the designer or manufacturer (e.g., textual data including English words is in a proper orientation when readable from left to right, top to bottom). For a second user sitting across from the first user, the displayed data appears upside down or inverted. Although the second user can still see the displayed data when it is upside down relative to the second user, this is not ideal for reading and comprehending the data. For the second user to see the displayed data in a correct or proper orientation relative to the second user without physically moving, the tablet computer must be physically rotated and passed from one user to another. Rotating and passing the tablet computer back and forth between users can be time-consuming and cumbersome. Additionally, repeated rotating and passing of the tablet computer back and forth from one user to another can cause damage to the hardware, which may be expensive to repair or replace.

Another drawback associated with multiple users sharing a single computer is that, it is difficult to control what content (or what type of content) is displayed to which users. It is often desirable to display different content to different users based on certain attributes or characteristics associated with each user. For example, during a learning session, a student and a teacher may work together at a computer to complete a lesson which includes a series of questions. It is appropriate for both the student and the teacher to see the questions. However, only the teacher should have access to an answer key.

Accordingly, there is a need for improved systems which enable multiple users participating in a collaborative activity to share data on a single display device.

### SUMMARY

The system disclosed herein enables a plurality of users or operators to share data via a single display device or screen of a computer. More particularly, the disclosed system displays a first subset of the data in a first orientation on the display device or screen. In response to a user input or request to share the data, the system displays a second subset of the data in a second different orientation on the display device or screen.

Different users may be associated with different subsets of the data. Preferably, only the subset of data associated with a particular user is made available (e.g., displayed at the correct orientation) to that user. That is, each user only has permission to see the subset data with which that user is associated. For example, in a learning session during which a student and a teacher share a screen of a computer, the student (e.g., the first user) can see a first subset of the data, which includes a series of questions of a lesson. The teacher (e.g., the second user) can see a second subset of the data, which includes the questions and the answers to those questions (e.g., an answer key). The data may be stored in a single data file, such as an XML file, which is tagged to display different subsets of the data to different users. For example, the data in the XML file may be tagged to display student content (e.g., a set of questions in a lesson) to a student and teacher content (e.g., an answer key) to a teacher.

The system determines which subset of the data to display in which orientation based on information which identifies each of the users and that user's respective location relative to the display device. For example, a first user located at or near a first side of the display device or screen is associated with the first subset of the data. A second user located at or near a second, opposite side of the display device or screen is associated with the second subset of the data. The system displays the first subset of the data in the first orientation, such that the displayed data is in a proper orientation with respect to the first user located at the first side of the display device. The displayed data is in the proper orientation with respect to the first user when it is readable or usable by the first user. That is, the displayed data is in a proper orientation with respect to the first user if it is displayed as it was intended to be viewed by the designer or manufacturer (e.g., textual data including English words is in a proper orientation when readable from left to right, top to bottom). Upon receiving a user input requesting to share the data, the system displays the second subset of the data in the second different orientation, such that the displayed data is in the proper orientation with respect to the second user.

It should be appreciated that, when the first and second users are located on opposite sides of the display device (as in the above example), the second orientation is substantially 180 degrees from the first orientation. The second orientation may be rotated substantially 180 degrees relative to the first orientation or flipped substantially upside down relative to the first orientation. In this example, all or nearly all of the data is displayed at one of the two orientations. In this manner, users sitting on opposite sides of the display may each view content in its proper orientation. In an alternative embodiment, in response to a user input to share the data, the system may cause the screen to split or divide into two separate display regions such that the first subset of data is displayed in the first orientation in a first display region of the screen and the second subset of data is displayed in the second orientation in a second different display region of the screen. In one example, the first display region has a bottom side which is adjacent to a bottom end of the screen and the second display region has a bottom side which is adjacent a top end of screen. The second subset of the data, which is displayed in the second display region, is flipped 180 degrees relative to the first subset of the data, which is displayed in the first display region.

The system enables the users to input information or commands (such as a request to change the orientation of the displayed data) via one or more input devices. In one example, the display device includes a touch-sensitive display device (e.g., a touch screen), configured to detect contact by a user's finger or a stylus. The system enables each user to make inputs via the touch screen. The system may identify each user and determine the location of that user based on inputs made by the user via the touch screen. For example, at the beginning of a collaborative session, each user may be required to make an input which identifies the user (e.g., a pin number) and/or indicates the location of the user relative to the touch screen (e.g., by touching the side of the touch screen that user is closest to). The system also enables one or more users to interact with or perform other operations on the displayed data via the touch screen, such as sharing, manipulating, modifying, editing or annotating the displayed data.

Each user may have a different stylus which is associated with or coded to that user. When a user utilizes his or her stylus to make inputs via the touchscreen, the system associates any information or commands inputted with the owner of that particular stylus. Depending on what is being displayed, contact by a user's stylus may or may not change the orientation of the displayed data. For example, a teach may prefer to leave the display oriented toward a student when helping a student with a lesson. However, the teach may prefer to have the display oriented toward the teacher when grading a lesson.

The disclosed system thus enables a plurality of users to share and interact with data displayed on a single display device or screen. The system determines which subsets of the data will be displayed in which orientations on the display device, such that a subset of the data intended for each specific user is displayed to that user in a proper orientation on the display device.

Additional features and advantages are described herein, and will be apparent from the following Detailed Description and the figures.

### BRIEF DESCRIPTION OF THE DRAWINGS

FIG. 1 is a block diagram showing one example of a network communications system for implementing the system disclosed herein.

FIG. 2 is a more detailed block diagram showing one example of a computing device.

FIG. 3 is a flowchart of an example process for enabling a plurality of users to share data on a single display device.

FIG. 4 is a schematic diagram illustrating a plan view of a horizontal display device on a surface of a table and two users located at opposite sides of the display device.

FIGS. 5 to 11 are screen shots of a display device in one example of the system disclosed herein.

FIG. 12 is a screen shot of a display device after a share data operation has been performed in another example of the system disclosed herein.

### DETAILED DESCRIPTION

The disclosed system enables a plurality of users to share a display device or screen of a computing device. In one example, as discussed below, the system may be implemented in a learning environment where a student and a teacher work collaboratively on instructional material, such as one or more lessons, provided to the computing device.

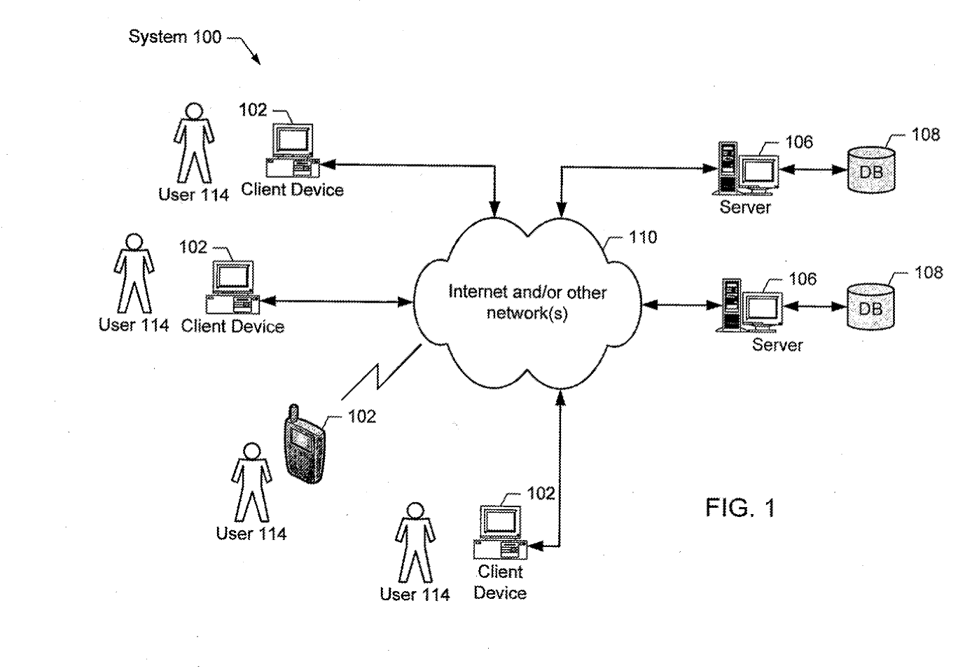

Referring now to FIG. 1, the disclosed system may be realized in a network communications system. A high level block diagram of an exemplary network communications system 100 is illustrated in FIG. 1. The illustrated system 100 includes one or more client devices 102, one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102. The databases 108 may be connected directly to the web server 106 and/or via one or more network connections.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

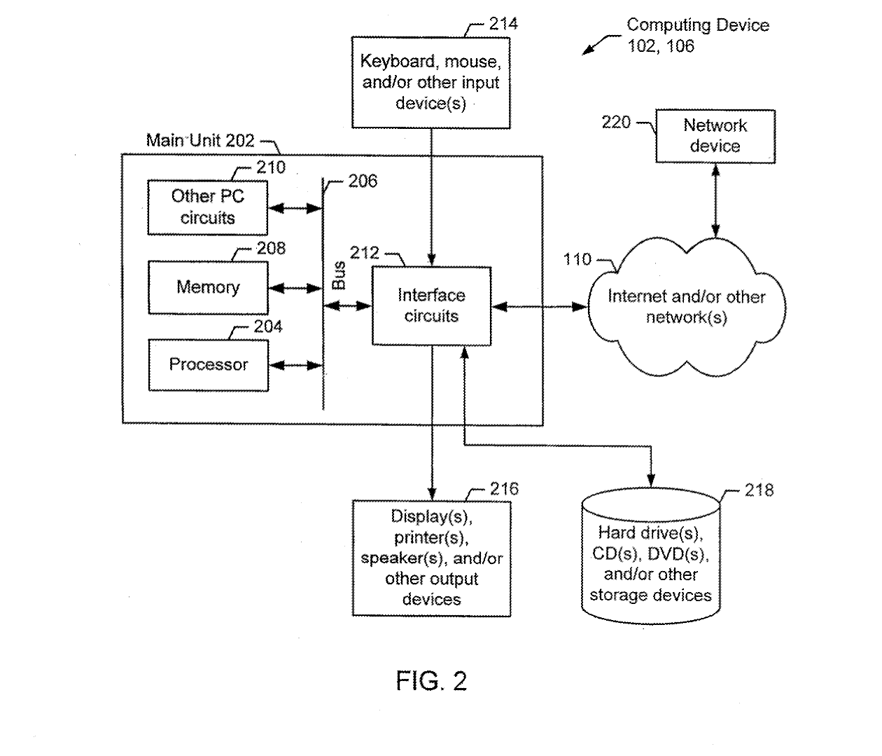

A more detailed block diagram of the electrical systems of a computing device (e.g., client device 102 and/or server 106) is illustrated in FIG. 2. Although the electrical systems of a client device 102 and a typical server 106 may be similar, the structural differences between the two types of devices are well known.

The client device 102 may include a personal computer (PC), a tablet-style computer, a personal digital assistant (PDA), an Internet appliance, a cellular telephone, or any other suitable communication device. The client device 102 includes a main unit 202 which preferably includes one or more processors 204 electrically coupled by an address/data bus 206 to one or more memory devices 208, other computer circuitry 210, and one or more interface circuits 212. The processor 204 may be any suitable processor. The memory 208 preferably includes volatile memory and non-volatile memory. Preferably, the memory 208 stores a software program that interacts with the other devices in the system 100 as described below. This program may be executed by the processor 204 in any suitable manner. The memory 208 may also store digital data indicative of documents, files, programs, web pages, etc. retrieved from a server 106 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the client device 102. For example, the display 216 may be used to display web pages and/or desktop pop-up data received from the server 106. The visual displays may include prompts for human input, run time statistics, calculated values, data, etc. Stylus-sensitive displays are currently available for use with tablet computers, and such displays may be used as device 216, as discussed below.

One or more storage devices 218 may also be connected to the main unit 202 via the interface circuit 212. For example, a hard drive, CD drive, DVD drive, and/or other storage devices may be connected to the main unit 202. The storage devices 218 may store any type of data or content used by the client device 102.

The client device 102 may also exchange data with other network devices 220 via a connection to the network 110. The network connection may be any type of network connection, such as an Ethernet connection, digital subscriber line (DSL), telephone line, coaxial cable, etc. Users 114 of the system 100 may be required to register with the server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

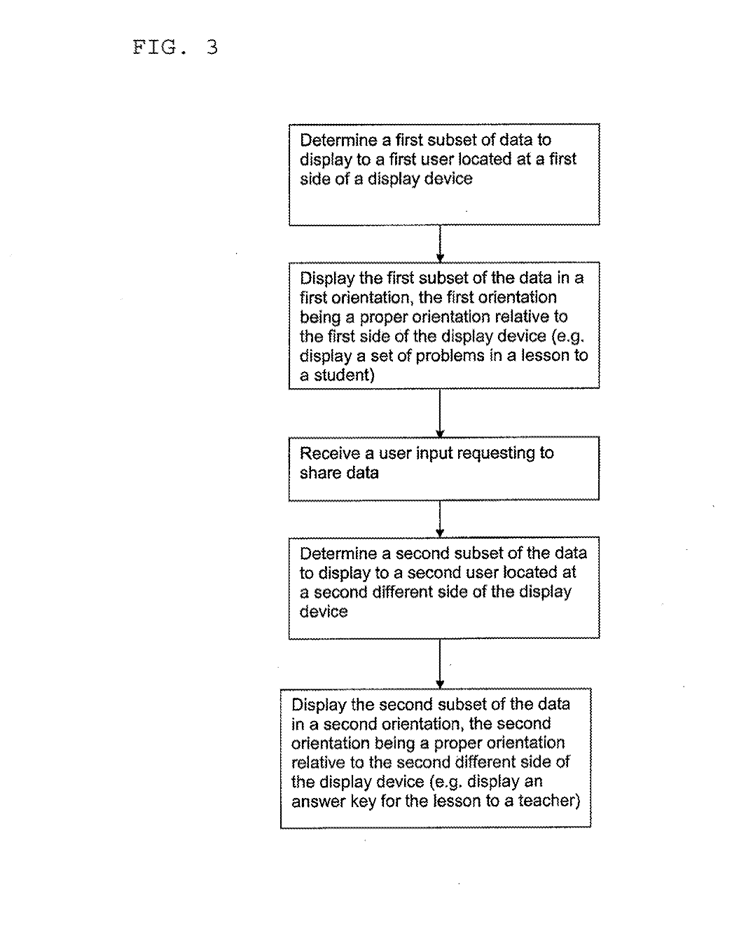

A flowchart of an example process 300 for enabling a plurality of users to share data on a single display device of a computing device is illustrated in FIG. 3. Preferably, the process 300 is embodied in one or more software programs which is stored in one or more memories and executed by one or more processors. Although the process 300 is described with reference to the flowchart illustrated in FIG. 3, it will be appreciated that many other methods of performing the acts associated with process 300 may be used. For example, the order of many of the steps may be changed, and many of the steps described are optional.

In general, the process 300 causes the computing device 102 to display different subsets of data to different users at an orientation suited to each user. The process 300 begins when the computing device 102 determines a first subset of the data to display to a first user located at a first side of the display device (block 302). The process 300 may cause the computing device 102 to identify a user based on identifying information provided to and/or stored by the system. In one example, the process 300 causes the computing device 102 to identify a user based on an input of a user identifier, such as an identification code, from a user. The user identifier may be used to determine which subset of the data should be displayed to that user.

The process 300 may cause the computing device 102 to enable the users to input identifying information (such as a user identifier) and/or commands via one or more input devices. In one example, the display device of the computing device 102 includes a touch-sensitive display device (e.g., a touch screen), configured to detect contact by a user's finger or a stylus. The process 300 may cause the computing device 102 to enable each user to make inputs via the touch screen. The process 300 may cause the computing device 102 to identify a user and/or determine a location of that user relative to the computing device 102 based on inputs made by the user via the touch screen. For example, at the beginning of a collaborative session, a user may be required to make an input which identifies the user and/or indicates the location of the user relative to the touch screen (e.g., which side of the touch screen that user is closest to). In one example, each user has a different stylus which is associated with or coded to that user. When a user utilizes his or her stylus to make inputs via the touchscreen, the process 300 causes the computing device 102 to associate any information or commands (such as a request to share the displayed data) inputted with the owner of that particular stylus.

Different users may be associated with different subsets of the data. Preferably, only the subset of data associated with a particular user is made available and/or displayed in the proper orientation for that user. For example, suppose a teacher and a student participate in a learning session during which the student and the teacher share a computer screen. When the student is operating the computer, the student (e.g., the first user) can see a first subset of the data, which includes a series of questions of a lesson. When the teacher is operating the computer, the teacher can see a second subset of the data, which includes the questions and the answers to those questions (e.g., an answer key).

The data may be stored in a single data file, such as an XML file, where the data is tagged to facilitate display of different subsets of the data to different users. For example, an XML file may include tags to display student content (e.g., a set of questions in a lesson) to a student and teacher.

Referring back to FIG. 3, after determining which subset of the data to display to the first user, such as based on a user identifier for the first user, the process 300 causes the computing device 102 to display the first subset of the data in a first orientation on the display device (block 304). The first orientation is a proper orientation relative to the first side of the display device. That is, when the first subset of data is displayed in the first orientation, that data is readily usable and readable by the first user. The first user can view the data as it was intended to be viewed by the designer or manufacturer. For example, textual data including English words are in a proper orientation when it is readable or usable from left to right, top to bottom.

The process 300 causes the computing device 102 to receive a user input requesting to share the data (block 306). In response to receiving the user input to share the displayed data, the process 300 causes the computing device 102 to determine a second subset of the data to display to a second user located at a second, different side of the display device (block 308). The process 300 causes the computing device 102 to display the second subset of data in a second different orientation on the display device (block 310). The second different orientation is in a proper orientation relative to the second different side of the display device.

If the first and second users are located on opposite sides of the display device, the second orientation is substantially 180 degrees from the first orientation. The second orientation may be rotated substantially 180 degrees relative to the first orientation or flipped substantially upside down relative to the first orientation. When the second subset of data is displayed in the second orientation on the display device, that data is readable or usable by the second user, but appears inverted or upside down to the first user, sitting on the opposite side of the display device.

In this manner, the disclosed process enables multiple users to share data displayed on a single display device. The system determines which subsets of the data will be displayed in which orientations on the display device (e.g., based on XML tagging and user location inputs), such that a subset of the data intended for each specific user is displayed to that user in a proper orientation on the display device.

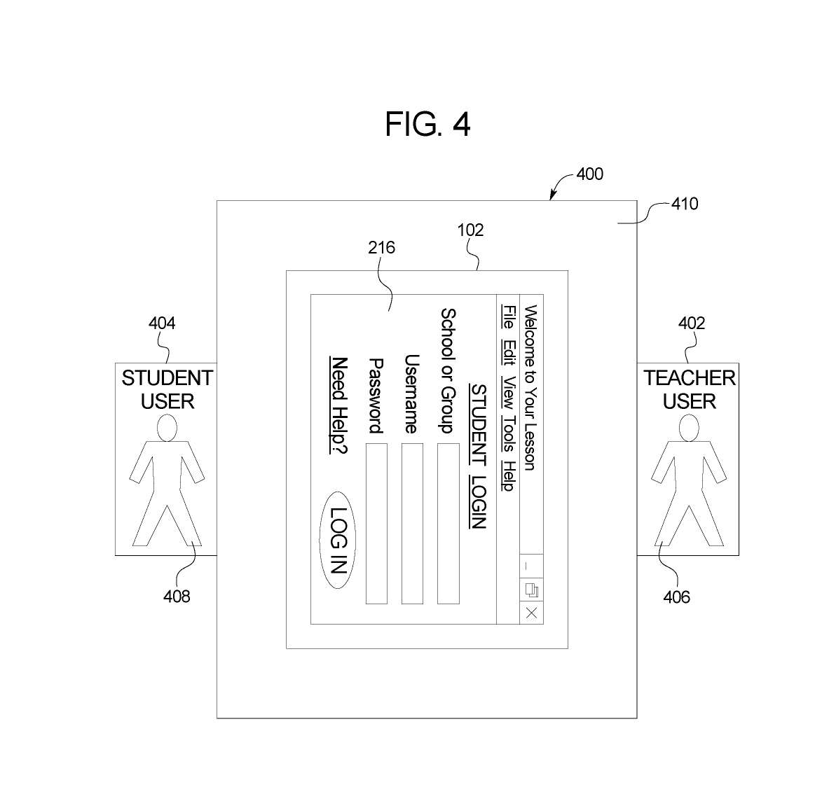

Referring now to FIGS. 4, 5, 6, 7, 8, 9, 10, and 11 in one example, the system is implemented in a learning environment where a teacher works face-to-face with a student during a instructional session. During the instructional session, the teacher and the student work collaboratively on one or more lessons provided to a single computing device 102 located on or supported by a table between the student and teacher.

FIG. 4 illustrates an overhead view of the table 400, around which the teacher and the student may be seated or standing. The table 400 has a teacher station 402 where a teacher 406 may be seated and a student station 404 where a student 408 may be seated. FIG. 4 shows one student station 404, but any number of student stations is possible depending on the desired student/teacher ratio. In FIG. 4, the table 400 is shown in the shape of a square with the teacher station on one side of the square and the student station on the opposite side of the square. It should be appreciated, however, that other shapes or configurations may be employed as long as the teacher can be face-to-face with each of the students at the table (at least part of the time). For example, the system may employ a U-shaped table that seats a plurality of students with the teacher located in the middle of the U, surrounded by students.

A computing device 102 is located on the surface 410 of the table 400 between the student and teacher. In the illustrated example, the computing device 102 is a tablet computer which includes a pen or stylus-based tablet input and display 216. Selected instructional materials or programs (e.g., lessons), may be provided to the tablet computer 102 either by the network, as described below, or run from a hard disk, RAM or other storage device on the computer itself. As illustrated in FIG. 4, the teacher 406 sits across from the student 404 at the table 400 in a face-to-face manner. The tablet computer 102 is located between the student 408 and the teacher 406, such that the student 408 and teacher 406 are located at opposite sides or ends of the tablet computer 102.

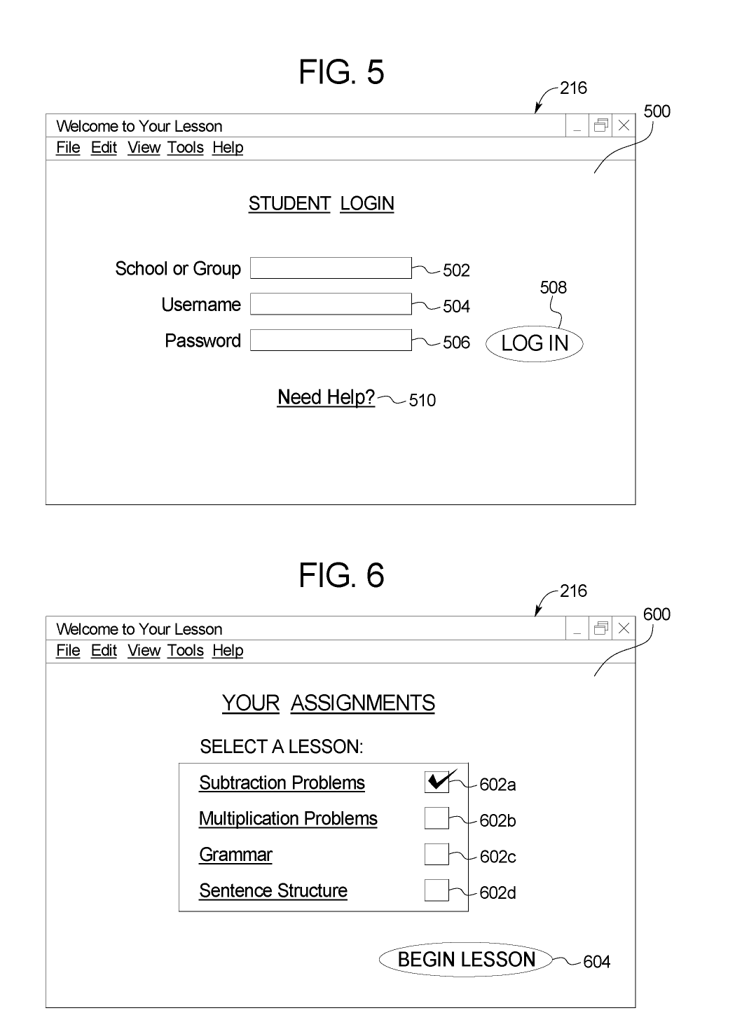

FIG. 5 illustrates a close-up view of the display 216 of the tablet computer 102 shown in FIG. 4 from the perspective of the student 408. More particularly, FIG. 5 is a screen shot of an exemplary login screen 500 for a student 408 who is about to begin working on a lesson. The login screen 500 may include a school or group text entry field 502 for the student to enter a school or group name or identification. A username text entry field 504 and password text entry field 506 may also be provided to enable the student to maintain privacy of their information. A soft-button 508 may be provided for the student to select for submission of the information in the text entry fields 502, 504, and 506. The system accepts the login information from the student and authenticates the student, such as by accessing a database to confirm that the user is a student as provided by a student profile.

FIG. 6 is a screen shot of an exemplary lesson screen 600 of the student. The lesson screen 600 may include a number of selectable options or boxes 602a, 602b, 602c, and 602d which each correspond to a lesson to be completed by the student. For example, as illustrated in FIG. 6, the selectable options or boxes 602a, 602b, 602c, and 602d include “Subtraction Problems,” “Multiplication Problems,” “Grammar,” and “Sentence Structure.”

The student (or the teacher with or without flipping the display orientation) may select a lesson by selecting one of the boxes 602a, 602b, 602c, and 602d. For example, using a stylus, the student may select the first box 602a, which corresponds to the “Subtraction Problems” lesson. A “Begin Lesson” soft-button 604 may be provided for the student to select or activate for submission of the lesson selection. It should be appreciated that other types of input devices, such as a mouse, trackball, a scroll wheel, a fingerprint reader, a touch pad, a sweep sensor, or the like may also be used with the tablet computer. One of more of these devices may be integrated with the tablet computer and/or exist separately.

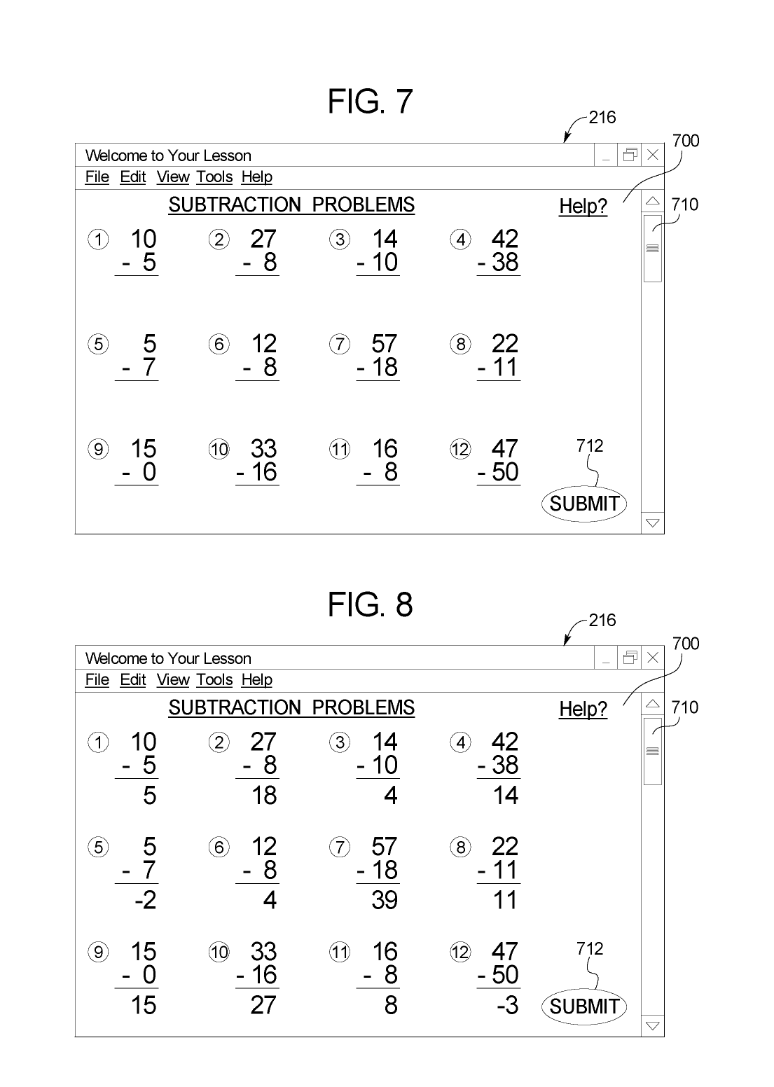

In response to the submission of the lesson selection, the computer causes lesson content to be displayed to the student. As illustrated in FIG. 7, the screen displays a document which includes a series of subtraction problems. More particularly, the document includes twelve subtraction problems to be answered by the student. The document is displayed in a first orientation which is the proper orientation for the student. In other words, the data is displayed such that the student can read the textual content displayed on the screen in a conventional left to right manner. The screen also displays a vertical scroll bar 710 for scrolling up and down the document.

In the illustrated example, the student answers the displayed subtraction problems by physically entering the answer on the screen. Using the stylus, the student solves the problems and inputs answers to those problems via the touch screen. The tablet computer interprets gestures and contacts made using stylus in order to manipulate data, enter text, and the like.

As illustrated in FIG. 8, the student has written in an answer for each problem below the problem, as in a traditional written mathematics exercise. When the student has completed the subtraction problems, and it is time for the teacher to review the student's work, either the teacher or the student activates the re-orientation tool 712, which in this example is a soft button labeled with the word “Submit.”

Activating the reorientation tool 712 causes an adjustment or change in the orientation of the displayed data. That is, activating the re-orientation tool 712 causes the displayed data to flip or rotate from a first orientation to a second different orientation on the display device. In the illustrated example, activating the reorientation tool 712 includes contacting a surface or soft button 712 of the touch screen. Contacting the surface of the touch screen can be accomplished, for example, through use of a stylus or finger, as described above. It should be appreciated, however, that other input devices may be used. It should also be appreciated, that the activation of the reorientation tool 712 may be accomplished in different ways. For example, a user can activate the reorientation tool by causing a pull-down menu to appear on the display. The reorientation of the displayed data can be accomplished by choosing a degree of reorientation, e.g., 180 degrees, from the pull-down menu. The reorientation of the displayed data may occur in response to other events or conditions which are unrelated to or separate from receiving a user request or input to change the orientation of the displayed data. For example, the change in orientation of the displayed data may automatically occur after a designated period of time.

In the illustrated example, after the student activates the reorientation tool 712 by pressing the soft button 712, the system causes the displayed data to flip or rotate 180 degrees. FIG. 9 shows a screen shot after the orientation of the displayed data has been changed from the first orientation to a second different orientation which is 180 degrees from the first orientation. The screen shot of FIG. 9 is shown from the perspective of the student. Since the displayed data is displayed in the second different orientation, the data appears invented or upside down relative to the student. However, the data is now displayed in a correct orientation with respect to a teacher located on the opposite side of the computer. That is, the data is displayed in such a way that the teacher can read the textual content displayed on the screen in a conventional left to right manner.

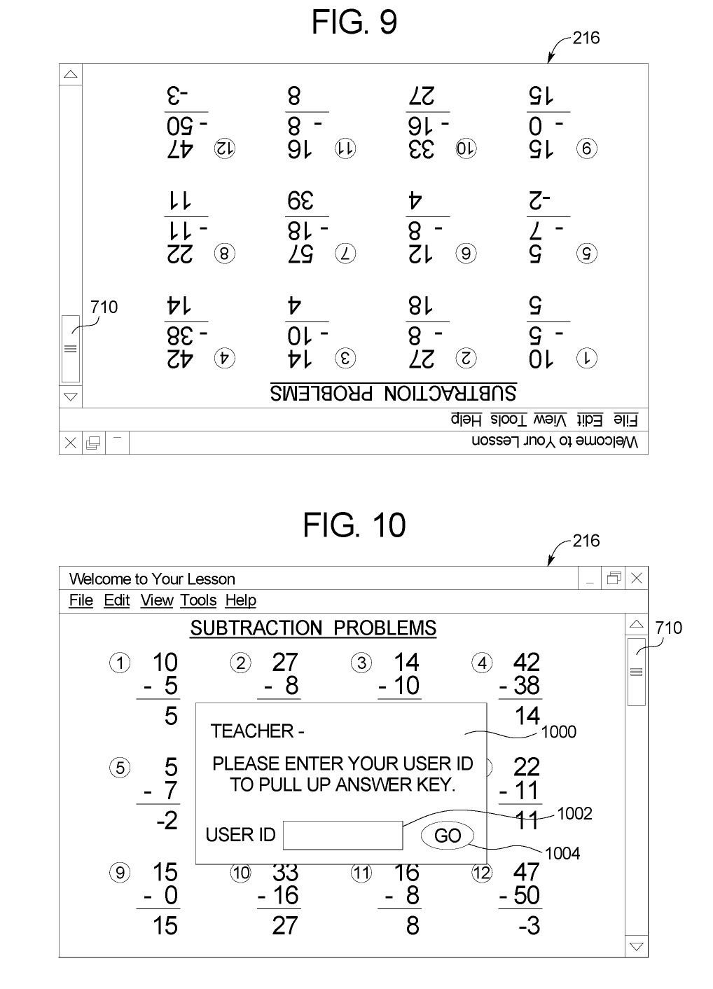

FIG. 10 shows the screen of FIG. 9, but from the perspective of the teacher. As illustrated in FIG. 10, the teacher can see the problems that were presented to the student as well as the student's responses to the problems. Additionally, a window 1000 (e.g., layer region) is displayed on the screen which enables the teacher to retrieve an answer key which includes the correct answers to the questions for comparison with the student's answers. As illustrated in FIG. 10, the system requires the teacher to input a teacher identifier, such as a teacher identification code or PIN number, to access the answer key. The window 1000 may include user ID field 1002 for the teacher to enter an identification code. A soft-button 1004 may be provided for the teacher to select to submit the information in the user ID field 1002.

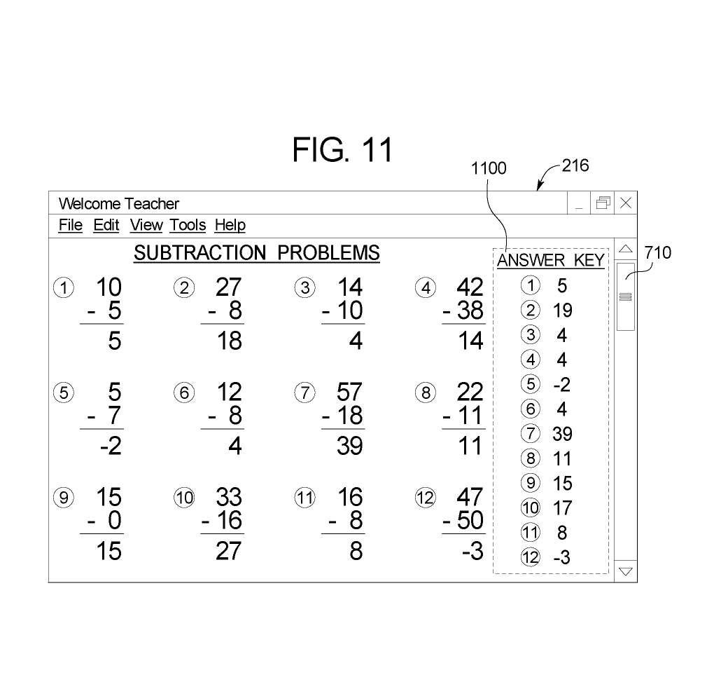

As illustrated in FIG. 11, the answer key 1100 is displayed on the screen adjacent to the problems and the student's answers to the problems. In this example, the answer key 1100 is displayed as a separate layer. The answers of the answer key 1100 may include text, graphics, video, or any other form of media to further assist the teacher in grading the student's answers. It should be appreciated that, in the illustrated example, the teacher can see all the information or content that was available to the student (e.g., the problems and the student's answers), as well as the answer key, which was not displayed or made displayable to the student (e.g. the answer key may be restricted to the teacher orientation).

In one embodiment, the answer key may be provided as a floating window (not shown) which appears on the screen in response to an input by the teacher. The floating window dynamically updates based on where the teacher's curser or sylus is placed on the screen. For example, the teacher, using his or her stylus, can scroll down to a particular question or problem of a lesson, such as question number seven, and the floating window appears adjacent to question number 7 and displays the answer to question number 7. Only the teacher, using his or her stylus, can reveal the answers to the questions. The floating window can be selectively hidden and/or caused to re-appear by the teacher. In this example, the teacher's orientation includes a different underlying logic than the student's orientation.

The system enables the teacher to evaluate or grade the student's work. As illustrated in FIG. 11, the lesson problems and the student's answers are displayed to the teacher. The answer key 1100 is also displayed to the teacher. For each of the problems of the lesson, the teacher compares the student's answer to that problem with the correct answer, as provided in the answer key 1100. For each problem, the teacher determines whether the student's answer matches the answer from the answer key 1100. A match results in a correct answer for the student. For each correct answer accumulated by the student, the teacher may award the student a number of points, such as one, two, or five points.

According to one method of scoring/grading the teacher evaluate the correctness of each of the student's answers electronically, and then manually sums up the number of points earned by the user. The sum of the points is the student's score or grade for the lesson. According to another method of grading/scoring, the teacher evaluates the correctness of each of the student's answers, but the system assists in determining the final score or grade. That is, the teacher indicates the correctness of each student answer, and the system computes the score, such as by determining the number of points to award for each correct answer and then adding up the points earned by the student. According to a further method of scoring/grading the system automatically evaluates whether or not the students answers are correct and then computes the final score or grade. It should be appreciated that the system may employ any one of the grading/scoring methods discussed above, any other suitable scoring method, or any suitable combination of such grading/scoring methods.

The disclosed system thus enables a plurality of users to share and interact with data displayed on a single display device or screen. The system determines which portion of the data will be displayed in which orientation on the display device, such that a subset of the data intended for each specific user is displayed to that user in a proper orientation on the display device.

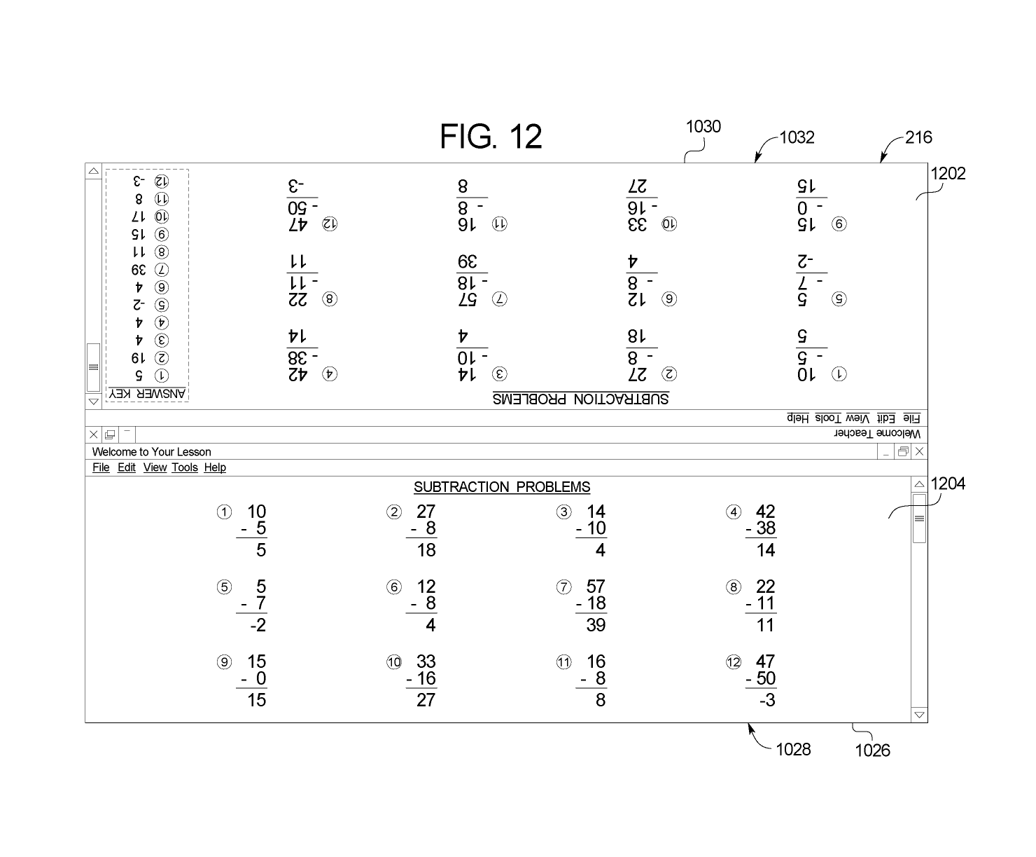

Referring now to FIG. 12, in an alternative embodiment, rather than flipping or rotating the displayed data by 180 degrees to share data between two users located on opposite sides of the display 216, the system may cause the display 216 to split or divide into two separate display regions 1204 and 1202 in response to a user input to share the data, such that the first subset of the data is displayed in the first orientation in the first display region 1204 and the second subset of the data is displayed in the second orientation in the second different display region 1202.

As seen in FIG. 12, the display has split in response to a user input to share data. This screen shot is from the perspective of the student. The first subset of the data (e.g., the student content, which includes the subtraction problems and the student's answers) is displayed in a first orientation in the first display region 1204. The second subset of the data (e.g., the teacher content, which includes the subtraction problems, the student's answers, and an answer key) is displayed in the second orientation in the second different display region 1202. As illustrated in this example, the first display region 1024 has a bottom side 1026 which is adjacent to a bottom end 1028 of the display 216 and the second display region 1202 has a bottom side 1030 which is adjacent to a top end 1032 of the display 216. From the student's perspective, the second subset of the data, which is displayed in the second display region 1202, is flipped 180 degrees relative to the first subset of the data, which is displayed in the first display region 1204.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A method of displaying data on a display device, said method comprising:
(a) displaying a first subset of the data in a first orientation on the display device, said first orientation being a proper orientation relative to a first user located on a first side of the display device;
(b) receiving at least one user input including a user identifier; and
(b) in response to receiving the user identifier, displaying a second different subset of the data in a second different orientation on the display device, said second different orientation being a proper orientation relative to a second user located on a second different side of the display device.

2. The method of claim 1, which includes selecting the first subset of the data based at least in part on a user profile associated with the first user and selecting the second subset of the data based at least in part on a user profile associated with the second user.

3. The method of claim 1, wherein the first and second subsets of the data are provided from a single data file.

4. The method of claim 3, wherein said single data file is tagged to display the first subset of the data to the first user and the second subset of the data to the second user.

5. The method of claim 1, wherein the second side of the display device is opposite from the first side of the display device.

6. The method of claim 1, wherein the second orientation is rotated one-hundred eighty degrees from the first orientation.

7. The method of claim 1, wherein the second orientation is flipped one-hundred eighty degrees from the first orientation.

8. The method of claim 1, wherein the display device includes a touch screen.

9. The method of claim 8, wherein receiving said at least one user input includes receiving the user identifier via the touch screen.

10. The method of claim 9, wherein the user identifier includes at least one of: (i) a user PIN number and (ii) an input made using a stylus associated with one of said users.

11. The method of claim 1, wherein the first subset of the data includes student content and the second subset of the data includes teacher content.

12. The method of claim 1, wherein the first subset of data is associated with a first underlying logic and the second subset of data is associated with a second different underlying logic.

13. The method of claim 1, wherein the predetermined data is restricted to the first orientation of the display.

14. A method of displaying data on a display device, said method comprising:
(a) displaying a first subset of the data in a first orientation in a display area of the display device, said first orientation being a proper orientation relative to a first user located on a first side of the display device; and
(b) in response to receiving at least one user input to share data:
(i) dividing the display area of the display device into a plurality of display regions, including a first display region and a second display region, wherein the first display region has a bottom side adjacent to a bottom end of the display area and a second display region has a bottom side adjacent to a top end of the display area;
(ii) displaying the first subset of the data in the first orientation in the first display region; and
(iii) displaying a second subset of the data in a second orientation in the second display region, said second orientation being a proper orientation relative to a second user located on a second side of the display device.

15. The method of claim 14, wherein the second subset of the data displayed in the second display region is flipped 180 degrees relative to the first subset of the data displayed in the first display region.

16. The method of claim 14, wherein the second subset of the data displayed in the second display region is rotated 180 degrees relative to the first subset of the data displayed in the first display region.

17. The method of claim 14, which includes selecting the first subset of the data based at least in part on a user profile associated with the first user and selecting the second subset of the data based at least in part on a user profile associated with the second user.

18. The method of claim 14, wherein the first and second subsets of the data are provided from a single data file.

19. The method of claim 18, wherein said single data file is tagged to display the first subset of the data to the first user and the second subset of the data to the second user.

20. The method of claim 14, wherein the second side of the display device is opposite from the first side of the display device.

21. The method of claim 14, wherein the display device includes a touch screen.

22. The method of claim 21, wherein receiving said at least one user input includes receiving a user identifier via the touch screen.

23. The method of claim 22, wherein the user identifier includes at least one of: (i) a user PIN number and (ii) an input made using a stylus associated with one of said users.

24. The method of claim 14, wherein the first subset of the data includes student content and the second subset of the data includes teacher content.

25. The method of claim 14, wherein the first display region is a layer region.

26. An apparatus for displaying data to a plurality of users, the apparatus comprising:
a processor;
an input device operatively coupled to the processor;
a display device operatively coupled to the processor; and
a memory device operatively coupled to the processor, the memory device storing instructions to cause the apparatus to:
(a) display a first subset of the data in a first orientation on the display device, said first orientation being a proper orientation relative to a first user located on a first side of the display device; and
(b) in response to receiving at least one user input to share the displayed data, display a second subset of the data in a second different orientation on the display device, said second different orientation being a proper orientation relative to a second user located on a second different side of the display device.

27. The apparatus of claim 26, wherein the instructions cause the apparatus to select the first subset of the data based at least in part on a user profile associated with the first user and select the second subset of the data based at least in part on a user profile associated with the second user.

28. The apparatus of claim 26, wherein the first and second subsets of the data are provided from a single data file.

29. The apparatus of claim 28, wherein said single data file is tagged to display the first subset of the data to the first user and the second subset of the data to the second user.

30. The apparatus of claim 26, wherein the second side of the display device is opposite from the first side of the display device.

31. The apparatus of claim 26, wherein the second orientation is rotated one-hundred eighty degrees from the first orientation.

32. The apparatus of claim 26, wherein the second orientation is flipped one-hundred eighty degrees from the first orientation.

33. The apparatus of claim 26, wherein the display device includes a touch screen.

34. The apparatus of claim 33, wherein the instructions cause the apparatus to receive said at least one user input by receiving a user identifier via the touch screen.

35. The apparatus of claim 33, wherein the user identifier includes at least one of: (i) a user PIN number and (ii) an input made using a stylus associated with one of said users.

36. The apparatus of claim 26, wherein the first subset of the data includes student content and the second subset of the data includes teacher content.

37. An apparatus for displaying data to a plurality of users, the apparatus comprising:
a processor;
an input device operatively coupled to the processor;
a display device operatively coupled to the processor; and
a memory device operatively coupled to the processor, the memory device storing instructions to cause the apparatus to:
(a) display a first subset of the data in a first orientation in a display area of the display device, said first orientation being a proper orientation relative to a first user located on a first side of the display device; and
(b) in response to receiving at least one user input to share data:
(i) divide the display area of the display device into a plurality of display regions, including a first display region and a second display region, wherein the first display region has a bottom side adjacent to a bottom end of the display area and a second display region has a bottom side adjacent to a top end of the display area;
(ii) display the first subset of the data in the first orientation in the first display region; and
(iii) display a second subset of the data in a second orientation in the second display region, said second orientation being a proper orientation relative to a second user located on a second side of the display device.

38. The apparatus of claim 37, wherein the second subset of the data displayed in the second display region is flipped 180 degrees relative to the first subset of the data displayed in the first display region.

39. The apparatus of claim 37, wherein the second subset of the data displayed in the second display region is rotated 180 degrees relative to the first subset of the data displayed in the first display region.

40. The apparatus of claim 37, wherein the instructions cause the apparatus to select the first subset of the data based at least in part on a user profile associated with the first user and select the second subset of the data based at least in part on a user profile associated with the second user.

41. The apparatus of claim 37, wherein the first and second subsets of the data are provided from a single data file.

42. The apparatus of claim 41, wherein said single data file is tagged to display the first subset of the data to the first user and the second subset of the data to the second user.

43. The apparatus of claim 37, wherein the second side of the display device is opposite from the first side of the display device.

44. The apparatus of claim 37, wherein the display device includes a touch screen.

45. The apparatus of claim 44, wherein the instructions cause the apparatus to receive said at least one user input by receiving a user identifier via the touch screen.

46. The apparatus of claim 45, wherein the user identifier includes at least one of: (i) a user PIN number and (ii) an input made using a stylus associated with one of said users.

47. The apparatus of claim 37, wherein the first subset of the data includes student content and the second subset of the data includes teacher content.
